(19) United States
(12) Patent Application Publication
(10) Pub. No.: US 2002/0170049 A1
(43) Pub. Date: Nov. 14, 2002

(54) Always-latest program code

(76) Inventor: Richard H. Suyehira, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/789,457

(22) Filed: Feb. 20, 2001

(51) Int. Cl. G06F 9/455

(52) U.S. Cl. 717/168

(57) ABSTRACT

A method and apparatus associated with upgrading programming of computer apparatus. In a preferred embodiment, a computer hard copy peripheral is provided with internet capabilities. An application program is provided on-board the peripheral to link the peripheral to the internet and a data base having latest version programs for the peripheral which can then be downloaded.

### FIELD OF THE INVENTION

The present invention relates generally to computer peripherals and, more particularly to a method and apparatus for upgrading computer printer apparatus controller-formatter firmware.

### BACKGROUND OF THE INVENTION

As the modern, post-industrial age shifts into the burgeoning management information systems age, computer automation of manufacturing, business services, government, military and other post-industrial societal needs require more reliable computer systems. As computer systems and networks develop in speed and complexity, there is an increased need for means to maintain those systems in both operationally stable and state-of-the art condition. Moreover, computer network products must be reliable and easily upgradable to match improvements in host computers and network servers. This is particularly true for computer peripherals, such as hard copy devices like printers and multitask machines that tend to evolve for universal application with fewer and less radical generation changes than their host computers.

A computer peripheral such as a printer is generally equipped with a controller board adapted to interface with a host computer. The controller board is provided with predetermined program routines, usually in a read only memory (ROM) and random access memory (RAM), for performing the host-peripheral interface functions and for controlling and driving the printer engine (as used in the art, engine generally is an all inclusive term used to refer to the various interactive components of the machine, such as the print media and printhead transport mechanisms, read-write devices, service stations, and the like, which are contained within the peripheral apparatus itself. The electronic circuitry comprising the controller board that is responsible for the running of the code is referred to as the formatter.

One prior solution to the aforesaid problems associated with maintaining computer peripherals is disclosed in U.S. Pat. No. 5,673,385, Sep. 30, 1997, filed by Mack et al. for a METHOD FOR DOWNLOADING SPECIAL CODE FROM A COMPUTER TO A HARD COPY APPARATUS (assigned to the common assignee herein and incorporated herein by reference). That invention provides a process for loading an off-board program into a computer peripheral apparatus connected to a host computer via a standard interface port. Random access memory of the peripheral apparatus is used by the host computer. The process includes the steps of: applying power to the apparatus, initializing the apparatus to achieve minimal operational conditions, and polling the interface port for a signal indicative of a host computer to peripheral apparatus program download request. Upon receiving the download request, the peripheral apparatus configures the random access memory to receive the program via the interface port, then provides a signal indicative of readiness to receive the program. The program can then be downloaded from the host, received in the random access memory, and run. If the download request is not recognized, the apparatus is fully initialized to its normal state of readiness for receiving common commands from the host computer.

With the now ubiquitous Internet, or World Wide Web, intertwined with worldwide business enterprises and original equipment manufacturers (OEM) having worldwide installed product bases, there is a need for improvement to methods and apparatus for upgrading such products by adapting to internet-type communications.

### SUMMARY OF THE INVENTION

In a basic aspect, the present invention provides a computerized method for upgrading computer peripheral programing, the method including: providing an internet accessible base having latest available computer peripheral programs; accessing said base remotely across the internet directly from a computer peripheral having a current version program; and downloading any version of related computer peripheral programs having a later version program than said current version program.

In another aspect, the present invention provides a computer peripheral controller-formatter device including: a programmable controller-formatter subsystem; and the subsystem having program code for connecting the device across an internet link and for downloading programs associated with computer peripheral functions.

In another aspect, the present invention provides a hard copy apparatus including: a programmable controller-formatter subsystem; and the subsystem having program code for connecting the device across an internet link and for downloading programs associated with computer peripheral functions.

It is an advantage of the present invention that it provides consistency to the process of introducing latest version driver programs into a computer peripheral, such as a hard copy apparatus controller-formatter.

It is another advantage of the present invention that it reduces manufacturing cost and time to market for all applications that require the execution of firmware code not built into on-board memory of installed base of products.

It is yet another advantage of the present invention that it maximizes the leverage of software and hardware tools across product lines and process domains.

It is still another advantage of the present invention that it eliminates the need for additional components, such as plug-in cartridge devices or SIMM circuits, to process routines not requisite to the basic functionality of a computer peripheral apparatus.

It is still a further advantage of the present invention that it provides a low cost, uniform method of field upgrade programming available over entire product lines.

It is yet a further advantage of the present invention that it provides high flexibility in product development and repair in that manufacturing can develop and modify test codes which can be delivered directly to the installed base of products.

The foregoing summary is not intended to be an inclusive list of all the aspects, objects, advantages, and features of the present invention nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches. Objects, features and advantages of the present invention will become apparent upon consideration of the following explanation and the accompanying drawings, in which like reference designations represent like features throughout the drawings. The drawings referred to in this specification should be understood as not being drawn to scale except if specifically annotated.

### DESCRIPTION OF THE DRAWINGS

FIG. 1 depicts an exemplary hard copy apparatus installation, coupled to internet-type facilities.

FIG. 2 is a flow chart illustrating the present invention.

### DETAILED DESCRIPTION OF THE INVENTION

Reference is made now in detail to a specific embodiment of the present invention which illustrates the best mode presently contemplated by the inventor for practicing the invention. Alternative embodiments are also briefly described as applicable. The term “internet” used hereinafter generically refers to the Internet, World Wide Wed, private intranets, and the like as are current to the state of the art.

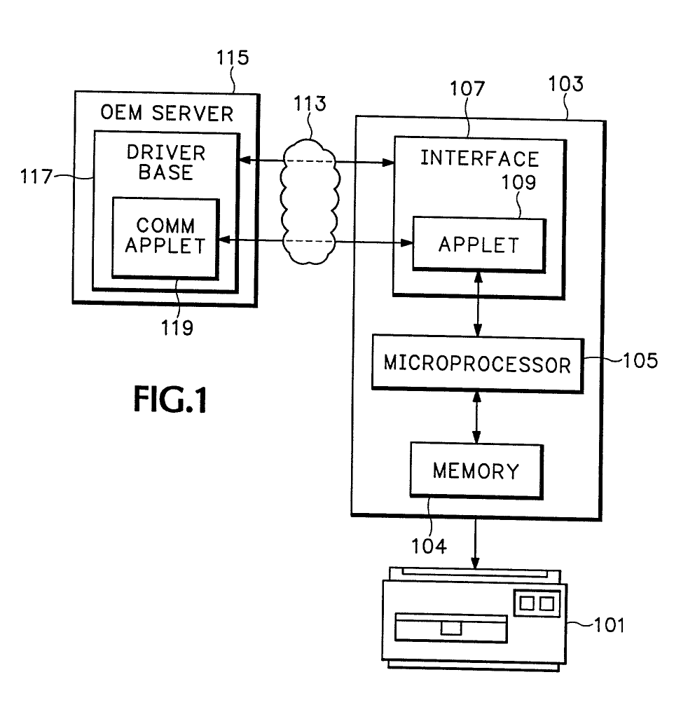

FIG. 1 demonstrates an exemplary computer peripheral, hard copy apparatus 101 (hereinafter “printer 101”), having an on-board (depicted by dashed arrow) controller-formatter printed circuit board 103 (“CFPCB 103” hereinafter). The CFPCB 103 is generally microprocessor 105 based, using known manner technology. Memory 104 and internet-type interface 107 subunits are now included in the CFPCB 103, that is, on-board the printer 101. The interface 107 includes an applet 109 associated with data and message transfers associated with the specific printer controller-formatter program routines (hereinafter referred to simply as the “code”) in memory. This applet 109 is provided by the OEM. The interface 107 is appropriately coupled to the internet, represented by a cloud 113 symbol.

At the OEM, or other OEM designated internet web site, 115 is a program, “CODE BASE,” 117 associated with and maintaining the latest software or firmware programs for the OEM's product line. A communications subprogram (COMM) 119 associated with the printer-based applet 109 is provided.

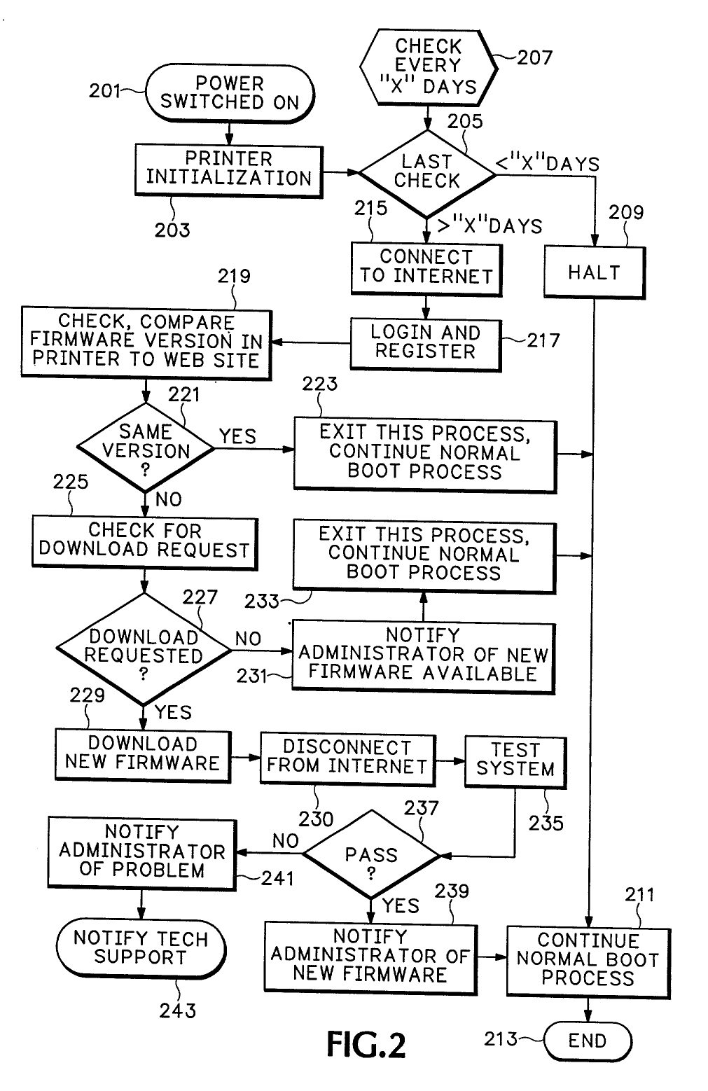

The operation of the present invention is now described with respect to FIG. 2. FIG. 2 is a flow chart of the computer code process program 200 of the present invention. Referring simultaneously to FIG. 1 may help in understanding the present invention.

As shown in step 201, the process is initiated when the printer 101 is powered on. As is known in the art, such printers have a built-in initialization, or “boot-up,” program (that reset defaults, runs self-test diagnostics, performs test print generation, and the like) automatically triggered, step 203, whenever a printer 101 is turned on.

Next, step 205, the program determines when the printer 101 last checked for program code updates. The schedule can be a fixed period, e.g., weekly, or optionally a programmable feature 207, “check every “x” days,” where “x” is selectable by the end-user or system administrator where more than one printer is involved such as a corporate site. If the check 205 is less than the period designated, “<x days” path of the flow chart, the program is halted, step 209, and the normal boot process, step 211, is continued until finished 213.

If the period has been exceeded, “>x days” path, the interface applet 109 connects the printer 101 to the internet 113, step 215. The interface 107 is provided with appropriate, known manner, client login and registration subroutines which are then run, step 217. Once the handshaking and security routines over the internet 113 are completed, the applet 109 initiates checking the printer 101 current code version against what is reported by the server 115 COMM applet 119 as the latest available code version in the server data base 117, step 219.

If the current code is the same as the latest code, step 221 Yes-path, the connection to the internet is ended, step 223, and normal boot routines are continued, step 211, until finished 213.

If the current code is not the latest version, step 221 No-path, the applet 109 performs a check, step 225, to determine if the client or system administrator wants the new version downloaded. For example, the administrator may not want to incur charges associated with a download and therefore disables any automatic download (step 229).

If latest version codes are to be automatically downloaded, step 227 Yes-path, the download from the OEM server 115 is initiated, step 229.

If a new version code is not automatically downloaded, step 227 No-path, a notification, e.g., an electronic mail message, is posted to the system administrator, step 231. Then, the internet link is severed, step 233, and normal boot process, step 211, continues until finished 213.

Once a new code is downloaded, a system test is initiated, step 235. If the test is successful, step 237 Yes-path, the system administrator is notified of the upgrade to the printer 101, step 239, and the normal boot-up process continued, step 211, until completed 213. The printer 101 is now ready for normal operations.

If the test fails, step 237 No-path, both the system administrator and technical support are notified, steps 241, 243.

Note that a download may in fact also update the on-board applet 109 itself.

Note also that a download may provide improved diagnostic tools useful to the system administrator, technical support, or OEM field engineers.

The foregoing description of the preferred embodiment of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . . ”

What is claimed is:

1. A computerized method for upgrading computer peripheral programing, the method comprising:
providing an internet accessible base having latest available computer peripheral programs;
accessing said base remotely across the internet directly from a computer peripheral having a current version program; and
downloading any version of related computer peripheral programs having a later version program than said current version program.

2. The method as set forth in claim 1, the downloading further comprising:
verifying successful download processes, and
disconnecting from the internet.

3. The method as set forth in claim 1 the step of accessing comprising:
accessing said base upon each power up cycle of the computer peripheral.

4. The method as set forth in claim 1, the step of accessing comprising:
upon peripheral initialization, determining if a scheduled time period has expired since a last determination whether the base has any version of related computer peripheral programs in a later version program than said current version program therein, and
if so, continuing with accessing said base remotely across the internet directly from a computer peripheral having a current version program and downloading any version of related computer peripheral programs having a later version program than said current version program, or
if not, skipping said steps of accessing and downloading and in lieu thereof continuing with peripheral initialization until the peripheral is in a normal operational mode.

5. The method as set forth in claim 1, said accessing comprising:
connecting to the internet,
performing handshaking and security routines with said internet accessible base,
determining if the base includes any version of related computer peripheral programs having a later version program than said current version program, and
if so, proceeding with downloading any version of related computer peripheral programs having a later version program than said current version program, or
if not, terminating connection to the internet and continuing with peripheral initialization until the peripheral is in a normal operational mode.

6. The method as set forth in claim 5 further comprising:
prior to the downloading, determining if any self-imposed restriction on downloading has been implemented, and
if so, terminating connection to the internet and continuing with peripheral initialization until the peripheral is in a normal operational mode, or
if not, proceeding with downloading any version of related computer peripheral programs having a later version program than said current version program.

7. The method as set forth in claim 2 further comprising:
following the step of downloading, performing a system test of the computer peripheral, and
if the test is passed, continuing with peripheral initialization until the peripheral is in a normal operational mode, or
if the test is failed, issuing a notification of failure associated with the test.

8. The method as set forth in claim 1, the downloading further comprising:
downloading updates to on-board program applets associated with internet communications.

9. The method as set forth in claim 1, the downloading further comprising:
downloading tools associated with system administration, technical support, or OEM field engineers diagnostics.

10. A computer peripheral controller-formatter device comprising:
a programmable controller-formatter subsystem; and
the subsystem having program code for connecting the device across an internet link and for downloading programs associated with computer peripheral functions.

11. The device as set forth in claim 10, the program code further comprising:
program code for accessing a server remotely across the internet directly from a computer peripheral having a current version of said programs associated with computer peripheral functions and for downloading any version of related computer peripheral programs having a later version program than current version related computer peripheral programs.

12. The device as set forth in claim 11, further comprising:
the programmable controller-formatter subsystem having program code for testing the computer peripheral programs.

13. A hard copy apparatus comprising:
a programmable controller-formatter subsystem; and
the subsystem having program code for connecting the device across an internet link and for downloading programs associated with computer peripheral functions.

14. The apparatus as set forth in claim 13, the program code further comprising:
program code for accessing a server remotely across the internet directly from a computer peripheral having a current versions of said programs associated with computer peripheral functions and for downloading any version of related computer peripheral programs having a later version program than current version related computer peripheral programs.

15. The apparatus as set forth in claim 13, further comprising:
the programmable controller-formatter subsystem having program code for testing the computer peripheral programs.
